(19) United States
(12) Patent Application Publication
(10) Pub. No.: US 2007/0162421 A1
(43) Pub. Date: Jul. 12, 2007

(54) Real-Time Messaging System for Bridging RDBMSs and Message Buses

(75) Inventors: Francis Pang, Oakland, CA (US); Olwen Tam, Daly City, CA (US); Kannan Ananthanarayanan, Fremont, CA (US); Elena I. Lora-Gallardo, Montrouge (FR)

Correspondence Address: JOHN A. SMART, 708 BLOSSOM HILL RD., #201, LOS GATOS, CA, 95032-3503, US

(73) Assignee: SYBASE, INC., Dublin, CA (US)

(21) Appl. No.: 11/306,852

(22) Filed: Jan. 12, 2006

(51) Int. Cl. G06F 17/30

(52) U.S. Cl. 707/2

(57) ABSTRACT

A SQL language interface for a messaging system, such as IBM MQ, is described. In one embodiment, for example, in a database system, a method is described for providing real-time message support for improved database connectivity, the method comprises steps of: defining Structured Query Language (SQL) extensions having commands that provide message-based connectivity for databases; receiving an SQL statement including a command specifying that a message be sent for communicating particular database data; upon execution of the SQL statement by the database system, creating an outbound message for communicating the particular database data to a destination; and posting the outbound database to a message bus, whereupon the particular database data is communicated asynchronously to the destination.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 337277 Bytes, created: Jan. 11, 2006 1:56:14 PM; Object ID: File No. 1; Object Contents: Source code.

### BACKGROUND OF THE INVENTION

1. Field of the Invention

The present invention relates generally to the field of data processing and, more particularly, to system and methodology providing message-based connectivity for databases.

2. Description of the Background Art

Computers are very powerful tools for storing and providing access to vast amounts of information. The first personal computers were largely stand-alone units with no direct connection to other computers or computer networks. Data exchanges between computers were mainly accomplished by exchanging magnetic or optical media such as floppy disks. Over time, more and more computers were connected to each other and exchanged information using Local Area Networks (“LANs”) and/or Wide Area Networks (“WANs”). Initially, such connections were primarily amongst computers within the same organization via an internal network. More recently, the explosive growth of the Internet has provided access to tremendous quantities of information from a wide variety of sources. The Internet comprises a vast number of computers and computer networks that are interconnected through communication links. In order to make the best use of these resources, various protocols have been developed. The IBM WebSphere MQ messaging system, which is a popular messaging platform widely used in financial services, is one such example.

IBM WebSphere MQ messaging system (or simply “MQ”) provides asynchronous messaging that can serve as a messaging backbone for deploying an enterprise service bus (ESB) as the connectivity layer of a service-orientated architecture (SOA). MQ can thus serve to integrate many platforms. Providing the messaging foundation for an enterprise service bus and assuring reliable message delivery, MQ can be used alone or combined with an application server. MQ enables software applications to exchange data and communicate using messages and message queues. MQ provides reliable, resilient application integration by passing messages between applications and Web services. It reduces the risk of information loss and the need to reconcile communicating IT systems by using queuing and transactional facilities that help preserve the integrity of messages across the network. In a typical operation, two queue managers are employed. The first manager manages queues and messages for a given source database, and the other manages queues and messages for a corresponding target or destination database. The two queue managers interact with end-user applications, queues, and channels to rapidly move data in the form of messages. MQ simplifies integration tasks by providing a functionally rich application programming interface (API) that removes the data movement and storage logic from the application, allowing developers/users to focus on the business logic. In this manner, MQ eliminates the need to write complex communications code. Description of the IBM WebSphere MQ messaging system/message bus is available from IBM, including via the Internet (e.g., currently at www-306.ibm.com/software/integration/wmq).

Today, a database system cannot simply execute SQL statements and have the output sent as MQ messages. The lack of the ability to propagate the data changes in real-time from the point of origination to the point of action is problematic, leading to poor visibility (e.g., decision makers are unaware of critical business events, hampering their ability to anticipate effectively), incorrect decisions (e.g., data that a consumer or application sees is out-of-date resulting in incorrect decisions), and delayed action (e.g., decision maker at point of action receives time-critical data too late, delaying appropriate response). These in turn result in reduced revenues, increased inefficiencies, higher cost, and unsatisfactory customer service.

Expectedly, database customers would like to take the activity that happens in the database and push that onto a message bus, such as MQ, in real-time. Presently, customers are not able to achieve real-time results with existing systems, but instead must settle for a slower, less efficient approach—polling. Applying polling technique, a client (customer) application polls the database at frequent intervals to see if anything has happened. Once something has happened, the client application retrieves the corresponding information from the database and publishes it to the message bus. However, this traditional polling approach of checking the database periodically for any data changes is intrusive and inherently inefficient: a significant delay is incurred between the time an activity happens and when that activity information reaches the message bus. Additionally, the current prior art approaches fail to take advantage of the native SQL language interface and related features available in modern RDBMSs. For example, existing solutions do not provide much in the way of transactional control, even though a given activity may span the database and the messaging bus. Accordingly, a better solution is desired.

What is needed is a database system providing a native SQL language interface for messaging systems, such as MQ. In this manner, one may better coordinate messaging with what is happening in real-time in the database, including responding appropriately to failure conditions. The present invention fulfills this and other needs.

### SUMMARY OF INVENTION

A SQL language interface for a messaging system, such as IBM MQ, is described. In one embodiment, for example, in a database system, a method of the present invention is described for providing real-time message support for improved database connectivity, the method comprises steps of: defining Structured Query Language (SQL) extensions having commands that provide message-based connectivity for databases; receiving an SQL statement including a command specifying that a message be sent for communicating particular database data; upon execution of the SQL statement by the database system, creating an outbound message for communicating the particular database data to a destination; and posting the outbound database to a message bus, whereupon the particular database data is communicated asynchronously to the destination.

In another embodiment, for example, a database system of the present invention providing real-time message support is described that comprises: a database storing database data; Structured Query Language (SQL) extensions having commands that provide message-based connectivity for databases; an execution module for receiving an SQL statement including a command specifying that a message be sent for communicating particular database data; and a real-time messaging system for creating an outbound message for communicating the particular database data to a destination upon execution of the SQL statement by the database system, and for posting the outbound database to a message bus, whereupon the particular database data is communicated asynchronously to the destination.

In yet another embodiment, for example, a database system of the present invention providing built-in, real-time messaging support is described that comprises: a database storing database data; a parser having native support for a language syntax providing real-time messaging; an execution unit, operating in response to commands parsed by the parser, for sending outbound messages in response to real-time changes to the database data; and a message bus for posting outbound messages for asynchronous delivery to a destination.

In another embodiment, for example, a method of the present invention is described for providing real-time messaging support to a database, the method comprises steps of: providing native language support for real-time messaging commands in query language statements; executing the commands during operation of the database, for creating real-time messages reporting changes to the database data; and posting the real-time messages to a message bus, for asynchronous delivery to a destination. In yet another embodiment, for example, a method of the present invention is described for providing real-time messaging support to a database that preserves the transactional integrity of the operations that span the database and message bus, the method comprises steps of: providing native language support for real-time messaging commands in query language statements that provide user level transactional integrity control that need to be adhered to during the execution; executing the commands during operation of the database, for creating real-time messages reporting changes to the database data; and posting the real-time messages to a message bus.

In another embodiment, for example, a method of the present invention is described for providing real-time messaging support to a database that provides a fine grain access control security that determines who is allowed to exchanged messages and who is not allowed to exchange messages with the message bus, the method comprises steps of: providing native language support for real-time messaging commands in query language statements that specifies the security privileges; executing the commands during operation of the database, for creating real-time messages reporting changes to the database data; and posting the real-time messages to a message bus. In still another embodiment, for example, in a database system, a method of the present invention is described for providing real-time message support that preserves transaction integrity of transactions that span across the database systems and a message bus, the method comprises steps of: defining Structured Query Language (SQL) extensions having commands that provide user-level transactional integrity control that is preserved during SQL statement execution; receiving an SQL statement including a command specifying that a message be sent for communicating particular database data; upon execution of the SQL statement by the database system, creating an outbound message for communicating the particular database data to a destination; and posting the outbound database to a message bus, whereupon the particular database data is communicated asynchronously to the destination.

In another embodiment, for example, a method of the present invention is described for providing real-time messaging support to a database, that provides fine-grain access control security that determines who is allowed to exchanged messages and who is not allowed to exchange messages with a message bus, the method comprises steps of: providing native language support for real-time messaging commands in query language statements that specifies security privileges; executing the commands during operation of the database, for creating real-time messages reporting changes to the database data; and posting the real-time messages to a message bus, for asynchronous delivery to a destination.

### BRIEF DESCRIPTION OF DRAWINGS

FIG. 1 is a very general block diagram of a computer system (e.g., an IBM-compatible system) in which software-implemented processes of the present invention may be embodied.

FIG. 2 is a block diagram illustrating the general structure of a client/server database system suitable for implementing a real-time messaging system (RTMS) of the present invention.

FIG. 3 is a block diagram illustrating the basic architecture of the system of the present invention (lower half of figure), as contrasted with the architecture of existing systems (upper half of figure).

FIG. 4 is a block diagram illustrating the real-time messaging system (RTMS) of the present invention in greater detail.

FIG. 5 is a high-level block diagram illustrating modified components of a database server that are germane to message processing.

FIGS. 6A-B comprise a high-level flowchart illustrating a methodology of the present invention for performing a “Message Send” operation, which occurs in response to invocation of the msgsend built-in function.

FIGS. 7A-B comprise a high-level flowchart illustrating a methodology of the present invention for performing a “Message Receive” operation, which is invoked via a msgrecv built-in function.

### DETAILED DESCRIPTION

Glossary

The following definitions are offered for purposes of illustration, not limitation, in order to assist with understanding the discussion that follows.

DDL: Short for Data Definition Language, a set of statements or language enabling the structure and instances of a database to be defined in a human-readable and machine-readable form. SQL, for example, contains DDL commands that can be used either interactively, or within programming language source code, to define databases and their components (e.g., CREATE and ALTER commands).

DML: Short for Data Manipulation Language, a set of statements used to store, retrieve, modify, and erase data from a database.

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Relational database: A relational database is a collection of data items organized as a set of formally-described tables from which data can be accessed or reassembled in many different ways without having to reorganize the database tables. The relational database was invented by E. F. Codd at IBM in 1970. A relational database employs a set of tables containing data fitted into predefined categories. Each table (which is sometimes called a relation) contains one or more data categories in columns. A feature of a relational database is that users may define relationships between the tables in order to link data that is contained in multiple tables. The standard user and application program interface to a relational database is the Structured Query Language (SQL), defined below.

SQL: SQL stands for Structured Query Language. The original version called SEQUEL (structured English query language) was designed by IBM in the 1970's. SQL-92 (or SQL/92) is the formal standard for SQL as set out in a document published by the American National Standards Institute in 1992; see e.g., “Information Technology—Database languages—SQL”, published by the American National Standards Institute as American National Standard ANSI/ISO/IEC 9075: 1992, the disclosure of which is hereby incorporated by reference. SQL-92 was superseded by SQL-99 (or SQL3) in 1999; see e.g., “Information Technology—Database Languages—SQL, Parts 1-5” published by the American National Standards Institute as American National Standard INCITS/ISO/IEC 9075-(1-5)-1999 (formerly ANSI/ISO/IEC 9075-(1-5)-1999), the disclosure of which is hereby incorporated by reference.

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., “RFC 793: Transmission Control Program DARPA Internet Program Protocol Specification”, the disclosure of which is hereby incorporated by reference. A copy of RFC 793 is available via the Internet (e.g., currently at www.ietf.org/rfc/rfc793.txt).

TCP/IP: TCP/IP stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial”, the disclosure of which is hereby incorporated by reference. A copy of RFC 1180 is available via the Internet (e.g., currently at www.ietf.org/rfc/rfcl180.txt).

Thread: A thread refers to a single sequential flow of control within a program. Operating systems that support multi-threading enable programmers to design programs whose threaded parts can execute concurrently. In some systems, there is a one-to-one relationship between the task and the program, but a multi-threaded system allows a program to be divided into multiple tasks. Multi-threaded programs may have several threads running through different code paths simultaneously.

URL: URL is an abbreviation of Uniform Resource Locator, the global address of documents and other resources on the World Wide Web. The first part of the address indicates what protocol to use, and the second part specifies the IP address or the domain name where the resource is located.

XML: XML stands for Extensible Markup Language, a specification developed by the World Wide Web Consortium (W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations. For further description of XML, see e.g., “Extensible Markup Language (XML) 1.0”, (2nd Edition, Oct. 6, 2000) a recommended specification from the W3C, the disclosure of which is hereby incorporated by reference. A copy of this specification is available via the Internet (e.g., currently at www.w3.org/TR/REC-xml).

Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

Computer-based Implementation

Basic system hardware and software (e.g., for desktop and server computers)

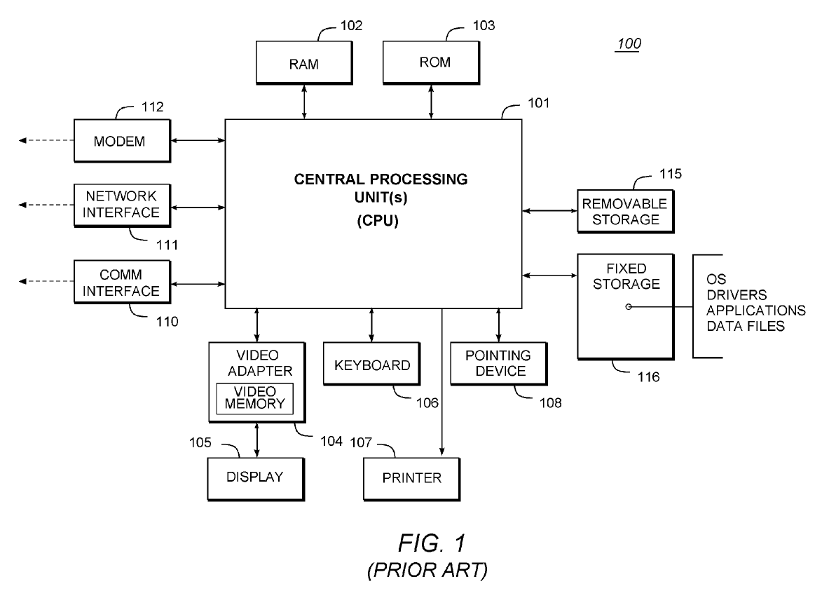

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, such as Microsoft Windows 9x, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

Client-server Database Management System

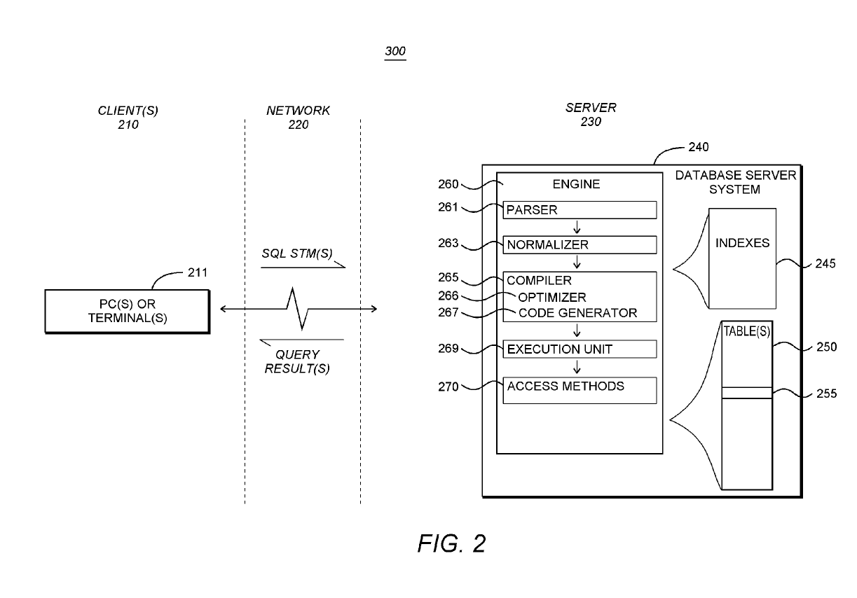

While the present invention may operate within a single (standalone) computer (e.g., system 100 of FIG. 1), the present invention is preferably embodied in a multi-user computer system, such as a client/server system. FIG. 2 illustrates the general structure of a client/server database system 200 suitable for implementing the present invention. (Specific modifications to the system 200 for implementing methodologies of the present invention are described in subsequent sections below.) As shown, the system 200 comprises one or more client(s) 210 connected to a server 230 via a network 220. Specifically, the client(s) 210 comprise one or more standalone terminals 211 connected to a database server system 240 using a conventional network. In an exemplary embodiment, the terminals 211 may themselves comprise a plurality of standalone workstations, dumb terminals, or the like, or comprise personal computers (PCs) such as the above-described system 100. Typically, such units would operate under a client operating system, such as a Microsoft® Windows client operating system (e.g., Microsoft® Windows 95/98, Windows 2000, Windows XP, or Windows Vista).

The database server system 240, which comprises Sybase® Adaptive Servers Enterprise (available from Sybase, Inc. of Dublin, Calif.) in an exemplary embodiment, generally operates as an independent process (i.e., independently of the clients), running under a server operating system such as Microsoft® Windows (as previously mentioned), UNIX (Novell), Solaris (Sun), or Linux (Red Hat). The network 220 may be any one of a number of conventional network systems, including a Local Area Network (LAN) or Wide Area Network (WAN), as is known in the art (e.g., using Ethernet, IBM Token Ring, or the like). The network 220 includes functionality for packaging client calls in the well-known Structured Query Language (SQL) together with any parameter information into a format (of one or more packets) suitable for transmission to the database server system 240.

Client/server environments, database servers, and networks are well documented in the technical, trade, and patent literature. For a discussion of Sybase® -branded database servers and client/server environments generally, see, e.g., Nath, A., “The Guide to SQL Server”, Second Edition, Addison-Wesley Publishing Company, 1995. For a description of Sybase® Adaptive Servers Enterprise, see, e.g., “Adaptive Server Enterprise 15.0 Collection: (1) Core Documentation Set and (2) Installation and Configuration,” available from Sybase, Inc. of Dublin, Calif. This product documentation is available via the Internet (e.g., currently at sybooks.sybase.com/as.html). The disclosures of the foregoing are hereby incorporated by reference.

In operation, the client(s) 210 store data in, or retrieve data from, one or more database tables 250, as shown at FIG. 2. Data in a relational database is stored as a series of tables, also called relations. Typically resident on the server 230, each table itself comprises one or more “rows” or “records” (tuples) (e.g., row 255 as shown at FIG. 2). A typical database will contain many tables, each of which stores information about a particular type of entity. A table in a typical relational database may contain anywhere from a few rows to millions of rows. A row is divided into fields or columns; each field represents one particular attribute of the given row. A row corresponding to an employee record, for example, may include information about the employee's ID Number, Last Name and First Initial, Position, Date Hired, Social Security Number, and Salary. Each of these categories, in turn, represents a database field. In the foregoing employee table, for example, Position is one field, Date Hired is another, and so on. With this format, tables are easy for users to understand and use. Moreover, the flexibility of tables permits a user to define relationships between various items of data, as needed. Thus, a typical record includes several categories of information about an individual person, place, or thing. Each row in a table is uniquely identified by a record ID (RID), which can be used as a pointer to a given row.

Most relational databases implement a variant of the Structured Query Language (SQL), which is a language allowing users and administrators to create, manipulate, and access data stored in the database. The syntax of SQL is well documented in the technical, trade, and patent literature. SQL statements may be divided into two categories: data manipulation language (DML), used to read and write data; and data definition language (DDL), used to describe data and maintain the database. DML statements are also called queries. In operation, for example, the clients 210 issue one or more SQL commands to the server 230. SQL commands may specify, for instance, a query for retrieving particular data (i.e., data records meeting the query condition) from the database table(s) 250. In addition to retrieving the data from database server table(s) 250, the clients 210 also have the ability to issue commands to insert new rows of data records into the table(s), or to update and/or delete existing records in the table(s).

SQL statements or simply “queries” must be parsed to determine an access plan (also known as “execution plan” or “query plan”) to satisfy a given query. In operation, the SQL statements received from the client(s) 210 (via network 220) are processed by the engine 260 of the database server system 240. The engine 260 itself comprises a parser 261, a normalizer 263, a compiler 265, an execution unit 269, and an access methods 270. Specifically, the SQL statements are passed to the parser 261 which converts the statements into a query tree—a binary tree data structure which represents the components of the query in a format selected for the convenience of the system. In this regard, the parser 261 employs conventional parsing methodology (e.g., recursive descent parsing).

The query tree is normalized by the normalizer 263. Normalization includes, for example, the elimination of redundant data. Additionally, the normalizer 263 performs error checking, such as confirming that table names and column names which appear in the query are valid (e.g., are available and belong together). Finally, the normalizer 263 can also look-up any referential integrity constraints which exist and add those to the query.

After normalization, the query tree is passed to the compiler 265, which includes an optimizer 266 and a code generator 267. The optimizer 266 is responsible for optimizing the query tree. The optimizer 266 performs a cost-based analysis for formulating a query execution plan. The optimizer will, for instance, select the join order of tables (e.g., when working with more than one table), and will select relevant indexes (e.g., when indexes are available). The optimizer, therefore, performs an analysis of the query and selects the best execution plan, which in turn results in particular access methods being invoked during query execution. It is possible that a given query may be answered by tens of thousands of access plans with widely varying cost characteristics. Therefore, the optimizer must efficiently select an access plan that is reasonably close to an optimal plan. The code generator 267 translates the query execution plan selected by the query optimizer 266 into executable form for execution by the execution unit 269 using the access methods 270.

All data in a typical relational database system is stored in pages on a secondary storage device, usually a hard disk. Typically, these pages may range in size from 1 Kb to 32 Kb, with the most common page sizes being 2 Kb and 4 Kb. All input/output operations (I/O) against secondary storage are done in page-sized units—that is, the entire page is read/written at once. Pages are also allocated for one purpose at a time: a database page may be used to store table data or used for virtual memory, but it will not be used for both. The memory in which pages that have been read from disk reside is called the cache or buffer pool.

I/O to and from the disk tends to be the most costly operation in executing a query. This is due to the latency associated with the physical media, in comparison with the relatively low latency of main memory (e.g., RAM). Query performance can thus be increased by reducing the number of I/O operations that must be completed. This can be done by using data structures and algorithms that maximize the use of pages that are known to reside in the cache. Alternatively, it can be done by being more selective about what pages are loaded into the cache in the first place. An additional consideration with respect to I/O is whether it is sequential or random. Due to the construction of hard disks, sequential I/O is much faster then random access I/O. Data structures and algorithms encouraging the use of sequential I/O can realize greater performance.

For enhancing the storage, retrieval, and processing of data records, the server 230 maintains one or more database indexes 245 on the database tables 250. Indexes 245 can be created on columns or groups of columns in a table. Such an index allows the page containing rows that match a certain condition imposed on the index columns to be quickly located on disk, rather than requiring the engine to scan all pages in a table to find rows that fulfill some property, thus facilitating quick access to the data records of interest. Indexes are especially useful when satisfying equality and range predicates in queries (e.g., a column is greater than or equal to a value) and “order by” clauses (e.g., show all results in alphabetical order by a given column).

A database index allows the records of a table to be organized in many different ways, depending on a particular user's needs. An index key value is a data quantity composed of one or more fields from a record which are used to arrange (logically) the database file records by some desired order (index expression). Here, the column or columns on which an index is created form the key for that index. An index may be constructed as a single disk file storing index key values together with unique record numbers. The record numbers are unique pointers to the actual storage location of each record in the database file.

Indexes are usually implemented as multi-level tree structures, typically maintained as a B-Tree data structure. Pointers to rows are usually stored in the leaf nodes of the tree, so an index scan may entail reading several pages before reaching the row. In some cases, a leaf node may contain the data record itself. Depending on the data being indexed and the nature of the data being stored, a given key may or may not be intrinsically unique. A key that is not intrinsically unique can be made unique by appending a RID. This is done for all non-unique indexes to simplify the code for index access. The traversal of an index in search of a particular row is called a probe of the index. The traversal of an index in search of a group of rows fulfilling some condition is called a scan of the index. Index scans frequently look for rows fulfilling equality or inequality conditions; for example, an index scan would be used to find all rows that begin with the letter “A”.

The above-described computer hardware and software are presented for purposes of illustrating the basic underlying computer components (e.g., database server) that may be employed for implementing the present invention. For purposes of discussion, the following description will present examples in which it will be assumed that there exists a “server” (e.g., database server) for purposes of implementing the processes described below. In typical operation, such a server communicates with one or more other computers, including “clients” (e.g., customer or end-user computers that are “database clients” of the server). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

Overview

Relational database management systems (RDBMSs) provide a store for data and a language (e.g., SQL) to query the stored data. Data stored in RDBMSs is inherently passive, and those systems do not generally provide mechanisms that allow them to initiate communication to external application systems. The data is just stored to be queried in the future. To enhance data flow between databases, a messaging bus or system may be incorporated. This provides an asynchronous communication paradigm where the sender and the receiver of a message are not required to be connected or active to exchange messages. For example, the IBM WebSphere MQ Messaging system (“IBM MQ”) provides an asynchronous communication paradigm where the sender and the receiver of a message are not required to be connected and active to exchange messages. This can be used advantageously to provide connectivity to RDBMSs. However, the prior art approach of using polling technique to place database information on a message bus has at best provided a problematic, inferior solution.

In accordance with the present invention, a native SQL language interface is provided that allows a database to send information to and receive information from a message bus, such as the IBM MQ message bus. (The present invention is not dependent on the messaging system of any particular vendor, but may instead be advantageously deployed with any messaging system compatible with the system and methods of the present invention described herein.) Importantly, the native SQL language interface of a RDBMS is enhanced with messaging grammar/syntax of the present invention to provide a bridge between database systems and corresponding messaging systems, so that events happening within a given database can be actively or passively sent to a desired messaging system, and events from the messaging system can be propagated into the database. By combining messaging along with database triggers, the data in a RDBMS may in effect become an event that can trigger meaningful actions, such as sending or receiving a message from the messaging system.

In this manner, the present invention proactively and non-intrusively moves time-critical events from databases to business applications. The moment a change occurs it is propagated, for example via the IBM MQ messaging infrastructure, thereby eliminating the delays in the flow of data from where it is captured to the systems and people that need to act upon it. This support allows an SQL application programmer to quickly add messaging (e.g., MQ messaging) to existing or new DBMS applications. For example in the case of IBM MQ as the messaging system, the SQL application programmer has full access to MQ messages, and can fully utilize all MQ features via the SQL language interface. The SQL language interface is simple to use, and provides design patterns that follow the design patterns established by the MQI API definition.

In the currently preferred embodiment, using the IBM MQ messaging system, the SQL interface of the present invention supports the following functionality:
Allow the message data to contain scalar data, relational data, or a combination of the two.
MQ pub/sub commands can be executed natively using the SQL interface.
MQ pub/sub topics can be specified from scalar data, relational data, or a combination of the two.
MQ message header properties can be specified from scalar data, relational data, or a combination of the two.
Messages on the MQ queue in XML format can be further queried using an XML XPath query.
Access to MQ message header properties in received messages.
Access to MQ message data in received messages.
DBMS DML events (e.g., update, insert, delete) can trigger messaging operations to put or get messages to or from a MQ queue.
The SQL interface supports MQ datagram, request reply, and report messages.
Transactional semantics are available on sent and received messages.
Message data can be the result of a SQL select in the XML format, adhering to standard SQLX format.
High degree of scalability and robustness is achieved through use of dedicated queue engines for performing messaging operation, relieving main stream database engines to deal with core database activities e.g., DML, DDL activities.

Since SQL is the programming language for the RDBMS, the native messaging support of the present invention provides rich language extensions to send and receive messages to/from messaging systems, such as MQ. The language extension is fully integrated into the RDBMS language (e.g., Transact SQL language for Sybase ASE databases). All SQL concepts are supported. For instance, relational data of any data type can be sent to and/or received from a message transported via the message bus. These SQL extensions allow new and existing applications to conveniently exchange messages (and corresponding database information) with messaging systems, including MQ. All told, the present invention's native SQL language interface for messaging provides a number of advantages, including: Full integration with SQL data type and expression evaluation; transactional integrity; high scalability; robust security; and seamless integration into RDBMSs.

System Components

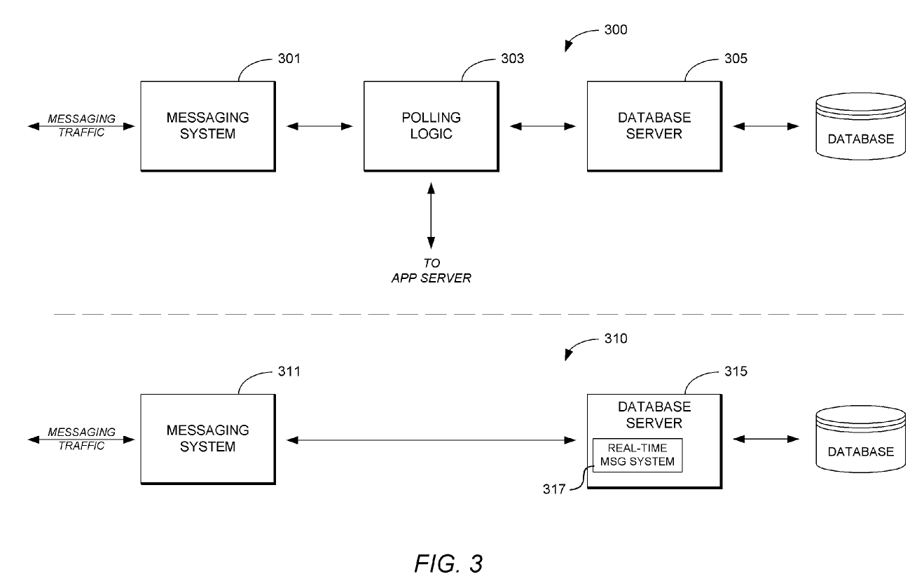

FIG. 3 is a block diagram illustrating the basic architecture of the system of the present invention, as contrasted with the architecture of existing systems. As shown in the upper half of the figure, an existing system 300 includes a database server 305 (e.g., Sybase ASE) and a messaging system 301 (e.g., IBM MQ). The 300 system also includes some sort of polling mechanism or logic 303 in between the database server 305 and the messaging system 301. The polling mechanism 303 may be provided by application software (e.g., client application logic) or provided by a server (e.g., server application). Typically, the polling mechanism 303 comprises “homegrown” (i.e., user-provided) logic to poll the database at some interval, for pushing database information on to the messaging queue of the messaging system. (The message queue makes the message traffic available to practically any authorized system that is capable of being connected directly or indirectly to the messaging system; the particular eventual reader of the message queue is not important to the discussion of system 300 and 310.) The disadvantages of the polling mechanism have been previously described (above).

The lower half of the figure illustrates an improved system 310 constructed in accordance with the present invention. Importantly, the improve system eliminates the “middle box” (i.e., polling mechanism or logic) by instead adopting a push approach. Therefore, the system 310 instead comprises a database server 315 connected directly to a messaging system 311, by virtue of the fact that the database server 315 includes a real-time messaging system 317. By eliminating the middle box, the system 310 reduces latency between the database and the messaging system. Therefore, changes that occur in the database are visible much more quickly on the messaging system. In accordance with the present invention, native SQL extensions are provided to incorporate native support for messaging within database applications. A message may be sent and/or received, for example, in response to a change in the data, or in response to an explicit SQL command (e.g., SELECT msgrecv()) issued by an application. Existing prior art solutions, in contrast, are one-way solutions—that is, polling for data changes which are then reported to the message bus (i.e., in a one-way manner). The present invention provides the full complement of communication, thereby leading to a more robust solution: programs may receive messages which are then in turn decipher to a level appropriate for the SQL or application programmer.

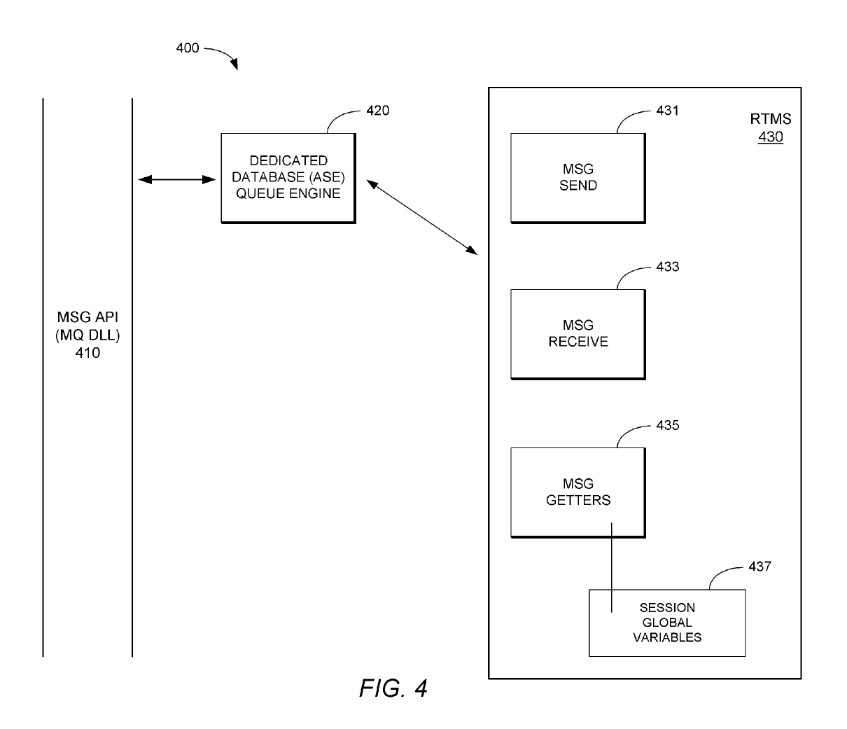

FIG. 4 is a block diagram illustrating the real-time messaging system (RTMS) in greater detail. As shown, the system 400 includes a real-time messaging system 430 connected to a dedicated database (Sybase ASE) queue engine 420, which in turn connects to a messaging API 410. The RTMS 430 includes a message send component 431, a message receive component 433, and message getters 435. The functionality of these modules will now be explained in further detail.

In order to send messages to a given vendor's messaging system, one typically must use the corresponding vendor-provided API libraries. Therefore, in the case of IBM MQ, for instance, one uses the MQ-specific API libraries (e.g., deployed as a dynamic link library), which is dynamically loaded for use (by the dedicated database queue engine 420). For scalability, all of the calls to the messaging API 410 are done on a separate database engine or process, referred to herein as the dedicated database queue engine 420. More particularly, this is a specialized database engine that will only interact with the message bus (message API) for the specific purpose of processing (e.g., MQ) messages. During system operation, the modules of the RTMS 430 actually schedule their work on the dedicated database queue engine 420 (to do the corresponding messaging API call). When the given API call returns (completes), it schedules itself back on the dedicated database queue engine 420 (where the work was initiated). System scalability is improved by redistributing the work of message queuing to a separate dedicated database queue engine. By isolating message processing in this manner, the main database engine of the system may perform other mission-critical database operations in instead of waiting on responses (e.g., returns from MQi.dll calls) from the messaging system.

When a message is read, properties of the message (e.g., message ID, correlation ID, and the like) are available for reading using the message getters 435, which are implemented as built-in message property functions. Session global variables 437 are employed to essentially prepackage the property getters (@@ variables), therefore facilitating an application program's access to commonly-sought message properties and context information (e.g., timestamps and the like). The “Message Send” (msgsend) command may be implemented as a SQL built-in function, which is a system built-in function providing a “Message Send” API call. In this manner, the “Message Send” function may be invoked in a stored procedure, in an SQL command or query, and/or inside in a database trigger. In a corresponding manner, a corresponding “Message Receive” (msgrecv) command may be implemented for receiving messages.

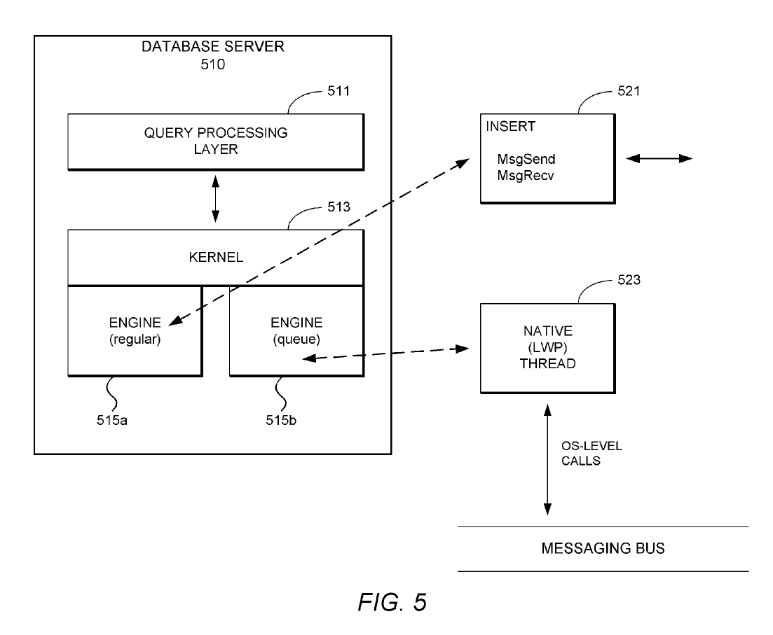

FIG. 5 is a high-level block diagram illustrating modified components of a database server 510 that are germane to message processing. Initially, SQL statements (i.e., a “SQL batch”) are received and processed by a query processing (QP) layer 511. The QP layer receives, as part of the batch for processing, an SQL statement that contains a “Message Send” or “Message Receive” command depending on what the particular command (at that point in the SQL logic) is desired to be used to interact with the messaging system. The QP layer parses the statement and compiles a query plan of execution. From the QP layer 510, the plan is passed to the database's kernel (layer) 513. The kernel 513 includes core logic for managing one or more database engines. Every engine is symmetrical; every engine has a QP kernel. Queue engines have the logic to execute messaging MQi API calls. During the execution of the query plan, the query plan executes on a regular engine until a messaging API call is encountered. At this point the query plan is rescheduled on to a queue engine to perform the messaging operation. Upon completion of the messaging operation, query execution resumes on the regular engine from where it was rescheduled.

Consider, for instance, the processing of an SQL statement that includes an SQL INSERT statement having a “Message Send” and/or “Message Receive” statement, such as shown at 521. In that case, the kernel 513 will set two database engines: a (regular) database engine 515a, and a (separate) queue database engine 515b. As previously described, the queue database engine is a dedicated database engine for performing queuing tasks. When the INSERT statement is executed, it will execute in the context of the (regular) database engine 515a (which in turn is executing in the context of a given client connection). When the system has to execute any messaging operation, the corresponding client connection will queue itself to run the messaging command in the context of the queue engine 515b. The queue engine proceeds to invoke a native, light-weight processing (LWP) thread at the operating system level, which in turn performs the actual communication with the messaging bus (i.e., the particular MQi API calls required for communicating with the messaging bus). It is at this point that the system performs all the logic for setting up MQi parameters, for correctly achieving the required “Message Send” or “Message Receive” logic required by the user.

Detailed Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

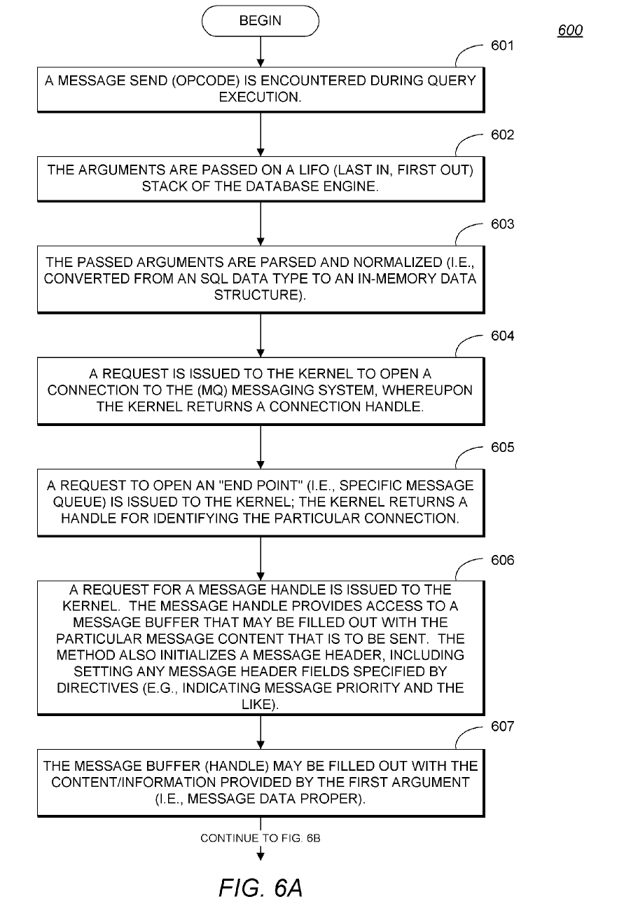

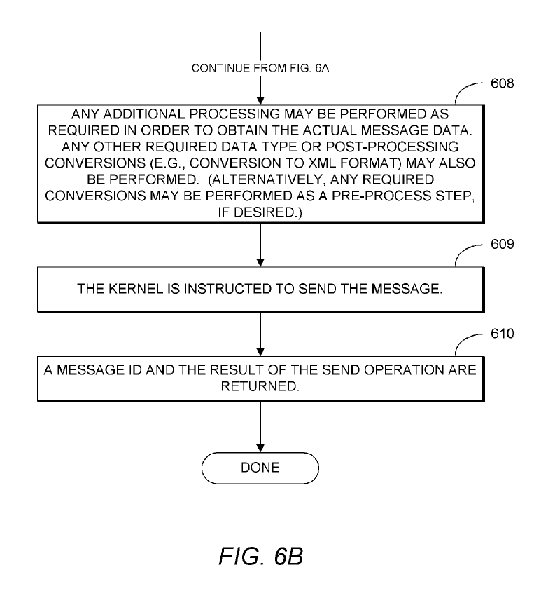

FIGS. 6A-B comprise a high-level flowchart illustrating a methodology 600 of the present invention for performing a “Message Send” operation, which occurs in response to invocation of the msgsend built-in function. The context of the following method steps occur during execution of the query plan (i.e., after query compiling has already occurred), specifically at the point when a “Message Send” opcode is encountered. Step 601 indicates that the method encounters a “Message Send” (opcode) during query execution. At this point, the query processing (QP) layer has already set up all of the parameters or arguments (pertinent to the “Message Send” command); that parsed information is captured in a context data structure (i.e., storing arguments for invoking the built-in function). These arguments are now given to the method. Specifically, at step 602, the arguments are passed on a LIFO (last in, first out) stack of the database engine (i.e., in a manner similar to construction of a stack frame on the stack register of an Intel x86 microprocessor for passing arguments for a function call). At step 603, the passed arguments are parsed and normalized (i.e., each converted from a SQL data type to an in-memory data structure). For a “Message Send” invocation, the arguments include: (1) message data proper (i.e., “payload” for the message being sent); (2) the “end point” MQ (i.e., a text string representing the name (URL) of the message queue that the message is being sent to); and (3) message properties or options (i.e., directives for this particular “Message Send” operation, such as message priority).

After all arguments have been converted to corresponding data structures, the method is now ready to open a connection to the messaging system. Thus, at step 604, a request is issued to the kernel to open a connection to the (MQ) messaging system, whereupon the kernel returns a connection handle (i.e., an identifier that may be used for sending messages on that particular connection). The kernel need not actually open the connection immediately, however. For example, even though a request to open a connection is made, an actual message for sending may not be posted to the kernel until several moments later. The request to open a connection is follow by a request to open an “end point” (i.e., specific message queue), as indicated at step 605. Again, the kernel returns a handle for identifying the particular connection. Now, the method may request a message handle, as shown at step 606. In effect, the message handle provides access to a message buffer that may be filled out with the particular message content that is to be sent. As part of this step, the method also initializes a message header, including setting any message header fields specified by directives (e.g., indicating message priority and the like).

At step 607, the message buffer (handle) may be filled out with the content/information provided by the first argument (i.e., message data proper). Any additional processing may be performed as required in order to obtain the actual message data, as indicated by step 608. For image data, for example, it may be necessary to retrieve several data pages from the database to construct the actual image data that comprises the “payload” for the message being sent. Any other required data type or post-processing conversions (e.g., conversion to XML format) may also be performed. (Alternatively, any required conversions may be performed as a pre-process step, if desired.) The message may now be sent. Thus, at step 609, the kernel is instructed to send the message (which performs the scheduling of the database engines, as previously described). As a final step, the (MQ) message ID and the result of the send operation (e.g., result code indicating success or failure) are returned, as indicated at step 610. The message ID is, in turn, returned as a return value of the built-in msgsend function invocation. Global session variables are set for the result code and timestamp, thus making this information made available to the application.

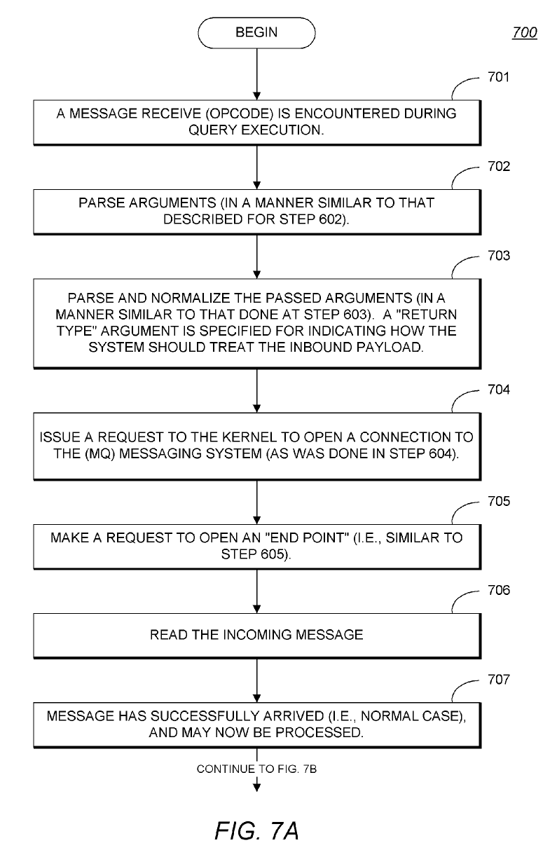

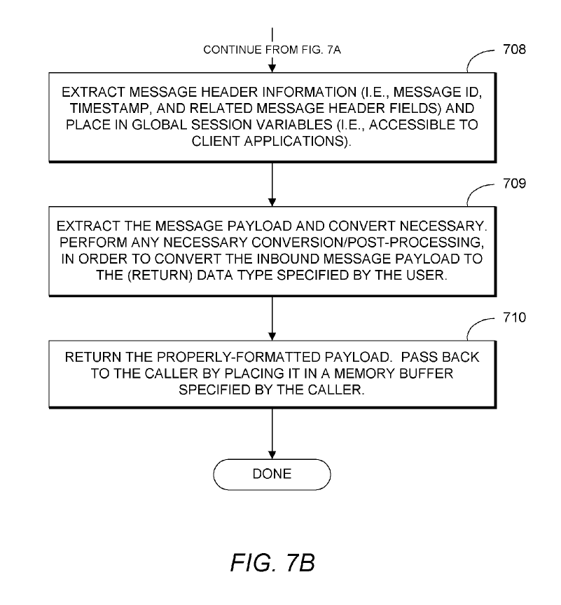

FIGS. 7A-B comprise a high-level flowchart illustrating a methodology 700 of the present invention for performing a “Message Receive” operation, which is invoked via a msgrecv built-in function. (Many of the method steps are analogous to those performed for the “Message Send” methodology 600.) At step 701, the method encounters a “Message Receive” (opcode) during query execution. At step 702, arguments are parsed (in a manner similar to that described for step 602). Arguments may include, for example, a (prescribed) timeout argument indicating how long the system should wait to receive a message before timing out. (If no message is received in that case, a null value will be returned.) At step 703, the passed arguments are parsed and normalized (in a manner similar to that done at step 603). Note, however, in contrast to the “Message Send” process, the arguments here do not include an outbound payload. However, a “return type” argument is specified for indicating how the system should treat the inbound payload. At step 704, a request is issued to the kernel to open a connection to the (MQ) messaging system (as was done in step 604). At step 705, a request is made to open an “end point” (i.e., similar to step 605). From this point on, the two methodologies diverges substantially from one another.

At step 706, the method reads the incoming message. This method step may be done in an asynchronous manner; the ASE session (not process) yields until the kernel layer reads the message. Additionally, the step may timeout should no message arrive before the above-described timeout (argument) interval occurs. Step 707 indicates that a message has successfully arrived (i.e., normal case). Now, the method may proceed to extract information from the message. Specifically, at step 708, message header information (i.e., message ID, timestamp, and related message header fields) is extracted and placed in global session variables (i.e., accessible to client applications). At step 709, the message payload is extracted, and converted as necessary. As previously described, the user's “Message Receive” command includes a data type of the payload (e.g., binary, text, or the like) as one of the arguments. Therefore, at this point, the method performs any necessary conversion/post-processing, in order to convert the inbound message payload to the (return) data type specified by the user. The method concludes at step 710 by returning the properly formatted payload. In the currently preferred embodiment, the properly-formatted message payload is essentially passed back to the caller by placing it in a memory buffer specified by the caller. After the fact, the client application may access the above-mentioned global session variables for obtaining the message header information.

SQL Language Interface

A preferred SQL language interface constructed in accordance with the present invention will now be described.

1. MQ Endpoint URL

The MQ endpoint URL consists of the following components:
a) MQ provider class, e.g., ‘ibm_mq’.
b) MQ channel name, e.g., ‘channel_{—}1’.
c) MQ transport protocol, e.g., ‘tcp’.
d) MQ hostname and port, e.g., ‘host_{—}1 (6789)’.
e) MQ queue manager name, e.g., ‘qmgr_{—}1’.
f) MQ remote queue manager name (optional), e.g., ‘rem_qmgr_{—}1’.
g) MQ queue name, e.g., ‘queue_{—}1’.

The MQ endpoint URL has the following syntax:

MQ_endpoint_URL ::= provider_name?qmgr_name,destination
provider_name ::= provider_class:provider_specific_url
provider_class ::= ibm_mq
provider_specific_url ::= channel_name/TCP/hostname(port_number)
channel_name ::= identifier
host_name ::= identifier
port_number ::= number
destination ::= qmgr_name[,remote_qmgr_name],queue_name
qmgr_name ::= qmgr = identifier
remote_qmgr_name ::= remote_qmgr = identifier
queue_name ::= queue = identifier

Following are example MQ URLs:
ibm_mq:CHANNEL2/TCP/HOST_{—}2(7371)?qmgr=QM2,queue=QUEUE_{—}2
ibm_mq:CHANNEL3/TCP/HOST_{—}3(6903)?qmgr=QM3,remote_qmgr=QM2,queue=QUEUE_{—}3

References to MQ provider and the MQ queue use the MQ endpoint URL.

2. Sending Messages to the MQ Bus

The SQL built-in function, msgsend(), sends a message to a MQ message bus. The first parameter is the message data, and the second parameter is the MQ URL. The MQ provider MQ message ID is returned. The function has the following syntax:

message_send_call ::= msgsend(message_body, end_point
[ options_and_properties ])
options_and_properties ::= [ option_clause ] [ properties_clause ]
[ header_clause ]
option_clause ::= [,] OPTION option_string
properties_clause ::= [,] MESSAGE PROPERTY option_string
header_clause ::= [,] MESSAGE HEADER option_string
message_body ::= scalar_expression | ( select_for_xml )
end_point ::= basic_character_expression

where:
option_string is any character string expression;
scalar_expression is any expression of any datatype; and
basic_character_expression is any character string expression.

The following example sends the message ‘Hello World’ to the MQ queue named ‘QUEUE_{—}2’:
declare @Q varchar(100) select @Q=“ibm_mq:CHANNEL2/TCP/HOST_{—}2(7371)?qmgr=QM2,queue=QUEUE_{—}2”
select msgsend(‘Hello World’, @Q)
0x414d51204652414e4349532e514d202041a3ebfb20014801

The next example sends the phone number of the employee whose employee id is 1234, to the MQ queue named ‘QUEUE_{—}2’. This example demonstrates the flexibility and richness of the language extensions to SQL by showing that data already residing in the database can be extracted using a typical correlated query and then sent to the messaging system. Note the phone number is obtained by querying the table employees using 1235 as the correlation.
declare @Q varchar(100)
select @Q=“ibm_mq:CHANNEL2/TCP/HOST_{—}2(7371)?qmgr=QM2,queue=QUEUE_{—}2”
select msgsend(phoneNumber, @Q) from emplyoyees where employeeId=1234
0x414d51204652414e4349532e514d202041a3ebfb20014802

The next example sends the result of a SQL query in SQLX format to the MQ queue named ‘QUEUE_{—}2’. The SQL query is a select of the employee names from the employees table where the city is ‘San Francisco ’.
declare @Q varchar(100)
select @Q=“ibm_mq:CHANNEL2/TCP/HOST_{—}2(7371)?qmgr=QM2,queue=QUEUE_{—}2”
select msgsend(
(select firstName, lastName
from employees where city=‘San Francisco’ FOR XML), @Q)
0x414d51204652414e4349532e514d202041a3ebfb20014803

The next example sends a ‘Happy Birthday’ message to the MQ queue named ‘QUEUE_{—}2’. Note that the message is constructed from a combination of scalar and relational data, where the relational data is obtained by selecting the first name of the employee whose id is 1234.
declare @Q varchar(100)
select @Q=“ibm_mq:CHANNEL2/TCP/HOST_{—}2(7371)?qmgr=QM2,queue=QUEUE_{—}2”
select msgsend(‘Happy Birthday’ to+firstname, @Q)
   from employees where employeeId=1234 0x414d51204652414e4349532e514d202041a3ebfb20014804

MQ message header properties are specified using the MESSAGE PROPERTY or MESSAGE OPTION clause to msgsend(). In the following example, the SQL command also specifies the “time-to-live” and “priority” MQ message header properties. The message will have a priority of 6, and a time to live of 24 hours.
declare @Q varchar(100)
select @Q=“ibm_mq:CHANNEL2/TCP/HOST_{—}2(7371)?qmgr=QM2,queue=QUEUE_{—}2”
select msgsend(‘a message with priority 6 and ttl 24hh’, @Q
   MESSAGE OPTION ‘ttl=24hh, priority=6’)

MQPUT features and concepts that can be directly specified to msgsend() may be summarized as follows:
a) Request receiving application or queue manager to reply with a REPORT message. The sender can request a Confirmation of Arrival (COA), a Confirmation of Delivery (COD), expiration, exception, Negative Action (NAN) or Positive Action (PAN) report.
b) Message header fields such as correlation id, and message id.
c) Message expiration, persistence, and priority.
d) Grouping and segmentation fields such as group id, sequence id and offset.
e) Inform receiving application on how to reply to a request message with the reply mode, reply queue manager, and reply queue. Dynamic (model) queues can be specified as the reply queue.
f) Undeliverable message policy.
g) MQ message types DATAGRAM, REQUEST, REPLY and REPORT.
h) All MQ pub/sub commands and parameters.

3. Receiving Messages from the MQ Bus

The SQL built-in functions, msgrecv(), receives a message from a MQ message bus. The first parameter is the MQ URL. The body of the MQ message is returned. The function has the following syntax:

message_recv_call ::= msgrecv( end_point
[ options_and_returns ])
options_filters_and_returns ::= [ option_clause ] [ returns_clause ]
option_clause ::= [,] OPTION option_string
returns_clause ::= [,] RETURNS sql_type
end_point ::= basic_character_expression
sql_type ::= varchar(integer) | java.lang.String | text
| varbinary(integer) | image

where:
option_string is any character string expression; and
basic_character_expression is any character string expression.

The following example reads the next message from the MQ message bus, from the queue ‘QUEUE_{—}2’. The message data is printed out.

declare @Q varchar(100)
select @Q = “ibm_mq:CHANNEL2/TCP/
HOST_2(7371)?qmgr=QM2,queue=QUEUE_2”
select msgrecv(@Q)
-------------------------------------------------------------------
Hello World

The next example reads the next message from the MQ message bus, from the queue ‘QUEUE_{—}2’. The message data is assigned to the SQL variable ‘@s’.

declare @Q varchar(100)
declare @s varchar(2000)
select @Q = “ibm_mq:CHANNEL2/TCP/
HOST_2(7371)?qmgr=QM2,queue=QUEUE_2”

select @s=msgrecv(@Q)

The following receive example reads the next message from the MQ message bus, from the queue ‘QUEUE_{—}2’. The message data is inserted into the table ‘messagesTable’.

declare @Q varchar(100)
select @Q = “ibm_mq:CHANNEL2/TCP/
HOST_2(7371)?qmgr=QM2,queue=QUEUE_2”
insert into messagesTable values(msgrecv(@Q))

MQGET features and concepts that can be directly specified to msgrecv() may be summarized as follows:
a) Read messages only when all messages in a group or all segments of a segmented message are present.
b) Browsing with and without locking of the browsed message. Message under the browse cursor can also be destructively read.
c) Expected size of the message can be specified. Messages that cannot fit in the message size specified can be selectively truncated or not read.
d) Granular control on closing and reopening of the browse and read cursors to allow newly sent messages with higher priorities to become visible.
e) Segmented messages can be returned as a single contiguous message.
f) Fine grain message selection by specifying correlation id, message id, group id, message segment and/or message offset.
g) MQOPEN open modes SHARED, EXCLUSIVE, QUEUE DEFAULT and BROWSE.
h) Timeout. If message is not available, return NULL.

4. MQPub/Sub (Publish/Subscribe)

MQ pub/sub commands can be directly sent to an MQ pub/sub broker. The MQ pub/sub commands can be constructed from scalar data, relational data, or a combination of the two. The SQL msgsend() builtin function is used to send MQ pub/sub commands directly to the MQ pub/sub broker. The following MQ pub/sub commands are supported:
Commands to register and deregister a publisher
Commands to register and deregister a subscriber
Command to delete a retained message.
Command to publish a message
Command to request an update for a message

The following example registers a message publisher and then publishes messages to the publication stream. A retained publication is also deleted from the publication stream.

-- @QM has the Queue Manager endpoint
declare @QM varchar(100)
-- @BROKER has the MQ pub/sub broker endpoint
declare @BROKER varchar(100)
-- @STREAM has the publication stream name
declare @STREAM varchar(100)
-- @CORRELID has the generated correlation id
declare @CORRELID varchar(100)
-- Initialize queue manager name, broker name, and publication stream
select @QM = ‘ibm_mq:channel_1/tcp/myhost(7366)?qmgr=QM1’
select @BROKER = ‘SYSTEM.BROKER.CONTROL.QUEUE’
select @STREAM = ‘Q1.STREAM’
-- Register the publisher for topicA
select msgsend(NULL, @QM + ‘,queue=’ + @BROKER

OPTION ‘rfhCommand=registerPublisher’
MESSAGE HEADER ‘correlationAsld=generate’

+ ‘,topics=topicA’
+ ‘,streamName=’ + @STREAM)

0x414d51204652414e4349532e514d202041a3ebfb20014a00
-- Save the generated correlation id
select @CORRELID = @@msgcorrelation
-- Send two publications on topicA
select msgsend(‘topic A, publication 1’,
@QM + ‘,queue=’ + @STREAM

OPTION ‘rfhCommand=publish’
MESSAGE HEADER ‘correlationAsld=yes’

+ ‘,correlationld=’ @@CORRELID
+ ‘,topics=topicA’)

0x414d51204652414e4349532e514d202041a3ebfb20014a01
select msgsend(‘topic A, publication 2’,
@QM + ‘,queue=’ + @STREAM

OPTION ‘rfhCommand=publish’
MESSAGE HEADER ‘correlationAsld=yes’

+ ‘,correlationld=’ + @@CORRELID
+ ‘,topics=topicA’)

0x414d51204652414e4349532e514d202041a3ebfb20014a02
-- Add another topic for this publisher
select msgsend(NULL, @QM + ‘,queue=’ + @BROKER

OPTION ‘rfhCommand=registerPublisher’
MESSAGE HEADER ‘correlationAsld=yes’

+ ‘,correlationld=’ + @@CORRELID
+ ‘,topics=topicB’

+ ‘,streamName=’ + @STREAM)
0x414d51204652414e4349532e514d202041a3ebfb20014a03
-- Publish retained message on topicB
select msgsend(‘topic B, retained publication 1’,
@QM + ‘,queue=’ + @STREAM

OPTION ‘rfhCommand=publish’
MESSAGE HEADER ‘correlationAsld=yes’

+ ‘,correlationld=’ + @@CORRELID
+ ‘,topics=topicB’

+ ‘,retainPub=yes’)
0x414d51204652414e4349532e514d202041a3ebfb20014a04
-- Publish second retained message on topicB
select msgsend(‘topic B, retained publication 2’,
@QM + ‘,queue=’ + @STREAM

OPTION ‘rfhCommand=publish’
MESSAGE HEADER ‘correlationAsld=yes’

+ ‘,correlationld=’ + @@CORRELID
+ ‘,topics=topicB’

+ ‘,retainPub=yes’)
0x414d51204652414e4349532e514d202041a3ebfb20014a05
-- Delete the retained publication on topicB
select msgsend(NULL, @QM + ‘,queue=’ + @BROKER

OPTION ‘rfhCommand=deletePublication’
MESSAGE HEADER ‘topics=topicB’

+ ‘,streamName=’ + @STREAM
0x414d51204652414e4349532e514d202041a3ebfb20014a06
--Deregister the publisher, for all topics
select msgsend(NULL, @QM + ‘,queue=’ + @BROKER

OPTION ‘rfhCommand=deregisterPublisher’
MESSAGE HEADER ‘correlationAsld=yes’

+ ‘,correlationld=’ + @CORRELID
+ ‘,deregAll=yes’

+ ‘,streamName=’ + @STREAM)
0x414d51204652414e4349532e514d202041a3ebfb20014a07

Initialize queue manager name, broker name, and publication stream

The next example registers a message subscriber and then reads messages from the subscriber stream.

-- @QM has the Queue Manager endpoint

| | |
|---|---|
| declare @QM | varchar(100) |

-- @BROKER has the MQ pub/sub broker endpoint
declare @BROKER varchar(100)
-- @SUBQUEUE has the subscription queue name

| | |
|---|---|
| declare @SUBQUEUE | varchar(100) |

-- @STREAM has the publication stream name
declare @STREAM varchar(100)
-- @CORRELID has the generated correlation id

| | |
|---|---|
| declare @CORRELID | varchar(100) |

-- Initialize queue manager name, broker name, and publication stream

| | |
|---|---|
| select @QM | = ‘ibm_mq:channel_1/tcp/myhost(7366)? |
| | qmgr=QM1’ |
| select @BROKER | = ‘SYSTEM.BROKER.CONTROL.QUEUE’ |

select @SUBQUEUE = ‘Q1.SUBSCRIBER’

| | |
|---|---|
| select @STREAM | = ‘Q1.STREAM’ |

```
-- Register the subscriber only for topicA
select msgsend(NULL, @QM + ‘,queue=’ + @BROKER
    OPTION ‘rfhCommand=registerSubscriber’
    MESSAGE HEADER ‘correlationAsId=generate’
        + ‘,topics=topicA’
        + ‘,streamName=’ + @STREAM
+ ‘,queueName=’ + @SUBQUEUE)
-----------------------------------------------------------------------
0x414d51204652414e4349532e514d202041a3ebfb20014a00
-- Save the generated correlation id
select @CORRELID = @@msgcorrelation
-- Add another topic for the subscriber
-- we will explicitly request an update for publications on this topic
select msgsend(NULL, @QM + ‘,queue=’ + @BROKER
    OPTION ‘rfhCommand=registerSubscriber’
    MESSAGE HEADER ‘useCorrelationAsId=yes’
        + ‘,topics=topicB’
        + ‘,streamName=’ + @STREAM
+ ‘,queueName=’ + @SUBQUEUE
+ ‘,pubOnReqOnly=yes’)
-----------------------------------------------------------------------
0x414d51204652414e4349532e514d202041a3ebfb20014a00
-- The publisher now publishes messages in the following order
```

| | |
|---|---|
| -- Message | Topic |
| -- ========= | ========== |
| -- message_1 | topicA |
| -- message_2 | topicB (*) |
| -- message_3 | topicA |
| -- message_4 | topicB (*) |
| -- ========= | ========== |

```
-- (‘*’ denotes a retained publication)
-- Get the first message on the subscriber queue, it will be
-- ‘message_1’ with topicA
select msgrecv(@QM + ‘,queue=’ + @SUBQUEUE OPTION
‘timeout=30ss’)
-----------------------------------------------------------------------
message_1
-- Get the next message on the subscriber queue, it will be
-- ‘message_3’ with topicA
select msgrecv(@QM + ‘,queue=’ + @SUBQUEUE OPTION
‘timeout=30ss’)
-----------------------------------------------------------------------
message_3
-- Request the broker to now send retained publications on topicB
select msgsend(NULL, @QM + ‘,queue=’ + @BROKER
    OPTION ‘rfhCommand=requestUpdate’
    MESSAGE HEADER ‘useCorrelationAsId=yes’
        + ‘,correlationId=’+ @CORRELID
        + ‘,topics=topicB’
        + ‘,streamName=’ + @STREAM
+ ‘,queueName=’ + @SUBQUEUE)
-----------------------------------------------------------------------
0x414d51204652414e4349532e514d202041a3ebfb20014a01
-- Get the next message on the subscriber queue, it will be
-- ‘message_4’ with topicB
select msgrecv(@QM + ‘,queue=’ + @SUBQUEUE OPTION
‘timeout=30ss’)
-----------------------------------------------------------------------
message_4
-- Deregister the subscriber, for all topics.
select msgsend(NULL, @QM + ‘,queue=’ + @BROKER
    OPTION ‘rfhCommand=deregisterSubscriber’
    MESSAGE HEADER ‘useCorrelationAsId=yes’
        + ‘,correlationId=’ + @CORRELID
        + ‘,deregAll=yes’
        + ‘,streamName=’ + @STREAM
+ ‘,queueName=’ + @SUBQUEUE)
-----------------------------------------------------------------------
0x414d51204652414e4349532e514d202041a3ebfb20014a03
```

5. Setting MQ Message Header Properties

The following MQ message header properties are directly settable from SQL.

| | msgsend( ) OPTION or |
|---|---|
| MQMD field | MESSAGE HEADER PROPERTY |
| Report | MESSAGE HEADER |
| | arrivalReport=yes \| withData \| withFullData \| no |
| | deliveryReport= yes \| withData \| withFullData \| no |
| | exceptionReport= yes \| withData \| withFullData \| no |
| | expirationReport= yes \| withData \| withFullData \| no |
| | negativeActionReport=yes \| no |
| | positiveActionReport=yes \| no |
| | replyCorrelationId=msgId \| correlationId |
| | replyMsgId=new \| original |
| | onNoDelivery=deadLetter \| discard |
| MsgType | OPTION |
| | msgType=datagram \| request \| reply \| report |
| Expiry | MESSAGE HEADER |
| | expiry=timespec |
| Feedback | MESSAGE HEADER |
| | feedback=integer |
| Format | MESSAGE HEADER |
| | formatName=string |
| Priority | MESSAGE HEADER |
| | priority=integer |
| Persistence | MESSAGE HEADER |
| | mode=persistent \| non-persistent \| default |
| MsgId | MESSAGE HEADER |
| | msgId=string \| hex_string |
| CorrelId | MESSAGE HEADER |
| | correlationId=string \| hex_string |
| ReplyToQ | MESSAGE HEADER |
| | replyToQueue=string |
| | replyToModel=string |
| ReplyToQMgr | MESSAGE HEADER |
| | replyToQMgr=string |
| GroupId | MESSAGE HEADER |
| | groupId=string |
| MsgSeqNumber | MESSAGE HEADER |
| | sequenceId=integer |
| Offset | MESSAGE HEADER |
| | offset=integer |
| MsgFlags | MESSAGE HEADER |
| | msgInGroup=yes \| no |
| | lastMsgInGroup= yes \| no |
| | msgSegment= yes \| no |
| | msgLastSegment= yes \| no |

6. Browse Mode

Browsing is used as a mechanism to peruse messages in a queue in a non-destructive manner. Browsed messages can be manipulated and examined the same way as a destructively read message. Once a message of interest is found, it can then be destructively read. The following example illustrates browse mode. For this example, assume the following messages already exist on the queue: AA BB CC DD EE FF GG HH.
declare @Q varchar(100)
declare @InputMode varchar(100)
select @Q=“ibm_mq:CHANNEL2/TCP/HOST_{—}2(7371)?qmgr=QM2,queue=QUEUE_{—}2”
select @InputMode=“inputMode=browse+Qdefault”
   Position browse cursor at the beginning and browse.
—This will return AA.
select msgrecv(@Q OPTION @InputMode+‘,browse=first’)
AA
   Browse the next message. This will return BB.
select msgrecv(@Q OPTION @InputMode +‘,browse=next’)
BB
   Browse the next message. This will return CC.
select msgrecv(@Q OPTION @InputMode+‘,browse=next’)
CC
   Read the message under the browse cursor. This will return CC.
select msgrecv(@Q OPTION @InputMode+‘,position=cursor’)
CC
   Reposition browse cursor at the beginning and browse.
   This will return AA.
select msgrecv(@Q OPTION @InputMode+‘,browse=first’)
AA
   Browse the next message. This will return BB.
select msgrecv(@Q OPTION @InputMode+‘,browse=next’)
BB
   Browse the next message. This will return DD.
select msgrecv(@Q OPTION @InputMode+‘,browse=next’)
DD
   Read the message under the browse cursor. This will return DD.
select msgrecv(@Q OPTION @InputMode+‘,position=cursor’)
DD
   Read the next message in queue order. This will return AA.
select msgrecv(@Q OPTION @InputMode+‘,browse=next’)
AA

7. Manipulating Message Header Properties

MQ message header properties from received messages can be directly manipulated by the SQL application logic using the SQL built-in functions and SQL session global variables. Using the SQL built in functions and session global variables, applications can dynamically inspect read messages and construct response information. The following SQL built in functions are used to access message header fields:

| TSQL Builtin Function | Description |
|---|---|
| msgpropcount( ) | Returns the number of header |
| | properties in a message |
| msgpropname( ) | Returns the name of the i'th |
| | header property in a message |
| msgpropvalue( ) | Returns the value of the named |
| | message property |
| msgproptype( ) | Returns the type of the named |
| | message property |
| msgproplist( ) | Returns a list of the message |
| | properties and their values in the |
| | form of an XML document. |

The following SQL session global variables contain more frequently accessed MQ message header information:

| TSQL Session Global | |
|---|---|
| Variable | Description |
| @@msgcorrelation | Correlation id of the last message sent or |
| | received |
| @@msgid | Message id of the last message sent or |
| | received |
| @@msgheader | Complete message header of last message |
| | received as an XML document |
| @@msgproperties | Topics from last Rules Formatting Messaging |
| | (RFH) message received as an XML document |
| @@msgreplyqmgr | Name of the reply queue manager if a |
| | request message |
| @@msgreplytoinfo | Name of the reply queue if a request |
| | message |
| @@msgstatus | MQ specific completion code of last |
| | messaging operation |
| @@msgtimestamp | Timestamp of the last message sent or |
| | received |

In the following example, MQ request/reply messaging is demonstrated. Both the requester and replier dynamically construct their reply messages. Also note that the requestor specifies the reply queue as a dynamic queue. The replier will reply on the dynamic queue.

| Requestor | Replier |
|---|---|
| -- Send request message. | |
| -- no correlation id is specified. we will | |
| -- use the generated one to read the reply. | |
| -- MODEL_Q is a model queue used to create | |
| -- the dynamic reply queue. | |
| -- replyToInputMode is how the dynamic | |
| -- reply queue is to be opened to read the | |
| -- reply | |
| select msgsend(‘the request message’, | |
| @Q | |
| OPTION ‘msgType=request’ | |
| MESSAGE_PROPERTY | |
| ‘replyToQueue=tempQ*’ | |
| + ‘,replyToModel=MODEL_Q’ | |
| + ‘,replyToInputMode’ | |
| + ‘=Qdefault’) | |
| -- Save the message correlation and | |
| -- the generated reply queue name | |
| select @RequestCorrelId = | |
| @@msgcorrelation | |
| select @ReplyQueue= | |
| @@msgreplytoinfo | |
| | -- Read the request message |
| | select msgrecv(@Q OPTION |
| | ‘timeout=30ss’) |
| | -- Send back a reply message |
| | -- correlation id of the request |
| | message |
| | -- as the correlation id of the reply |
| | -- message |
| | -- The reply is sent on the reply queue |
| | select msgsend(‘the reply message’, |
| | @@msgreplytoinfo |
| | OPTION ‘msgType=reply’ |
| | MESSAGE PROPERTY |
| | ‘correlationId=’ |
| | + @@msgcorrelation) |
| -- Read the reply message | |
| -- from the dynamic reply queue | |
| -- Use the correlation of the | |
| -- request message. | |
| select msgrecv(@ReplyQueue | |
| OPTION ‘correlationId=’ | |
| + @RequestCorrelId) | |

In the next example, a message is read, and some MQMD header fields are extracted:
declare @Q varchar(100)
declare @msg varchar(1000)
declare @report integer
declare @format varchar(100)
declare @encoding integer
select @Q=“ibm_mq:CHANNEL2/TCP/HOST_{—}2(7371)?qmgr=QM2,queue=QUEUE_{—}2”
select @msg=msgrecv(@Q OPTION ‘timeout=30ss’)
select @report=msgpropvalue(‘Report’, @@msgheader)
select @format=msgpropvalue(‘Format’, @@msgheader)
select @encoding=convert(integer, msgpropvalue(‘Encoding’, @@msgheader))

8. Transactional Support

How messaging operations (send/receive) are included in the SQL transaction is controlled by the “set transactional messaging” command. This command has three settings:

none —messaging operations are NOT part of the SQL transaction and SQL transactional commands (commit/rollback) have no affect on the messaging operation.

simple—messaging operations are part of the SQL transaction and SQL transactional commands (commit/rollback) will commit or rollback any messaging operations performed in the SQL transaction. Errors occurring from messaging operations will NOT affect the SQL transaction.

full—messaging operations are part of the SQL transaction and SQL transactional commands (commit/rollback) will commit or rollback any messaging operations performed in the SQL transaction. Errors occurring from messaging operations will cause the SQL transaction to abort.

The following example explains the effect when the transactional messaging mode is “none”.

```
set transactional messaging none
begin transaction
declare @Q varchar(100)
select @Q =
“ibm_mq:CHANNEL2/TCP/HOST_2(7371)?qmgr=QM2,
queue=QUEUE_2”
    select msgsend(‘a message’, @Q)
    insert into T values (100)
    select msgrecv(@Q)
commit
/*
Note:
a) Failure by msgsend( ) or msgrecv( ) will not rollback the transaction.
b) Failure by insert will not undo work done by msgsend( ).
*/
set transactional messaging none
begin transaction
declare @Q varchar(100)
select @Q =
“ibm_mq:CHANNEL2/TCP/HOST_2(7371)?qmgr=QM2,
queue=QUEUE_2”
    select msgsend(‘a message’, @Q)
    insert into T values (100)
    select msgrecv(@Q)
rollback
/* Note: rollback will not undo work done by msgsend( ) and
msgrecv( ) */
```

The following example explains the effect when the transactional messaging mode is “simple”.

```
set transactional messaging simple
begin transaction
declare @Q varchar(100)
select @Q =
“ibm_mq:CHANNEL2/TCP/HOST_2(7371)?qmgr=QM2,
queue=QUEUE_2”
    select msgsend(‘a message’, @Q)
    insert into T values (100)
    select msgrecv(@Q)
commit
/*
Note:
1. Failure by msgsend( ) or msgrecv( ) will not rollback the transaction.
2. Failure by insert will undo work done by msgsend( ).
*/
set transactional messaging simple
begin transaction
declare @Q varchar(100)
select @Q =
“ibm_mq:CHANNEL2/TCP/HOST_2(7371)?qmgr=QM2,
queue=QUEUE_2”
    select msgsend(‘a message’, @Q)
    insert into T values (100)
    select msgrecv(@Q)
rollback
/* Note: Rollback will undo work done by msgsend( ) and msgrecv( ). */
```

The following example explains the effect when the transactional messaging mode is “full”.

```
set transactional messaging full
begin transaction
declare @Q varchar(100)
select @Q =
“ibm_mq:CHANNEL2/TCP/HOST_2(7371)?qmgr=QM2,
queue=QUEUE_2”
    select msgsend(‘a message’, @Q)
    insert into T values (100)
    select msgrecv(@Q)
commit
/*
Note: Failure by msgsend( ), msgrecv( ) or insert will rollback the
transaction.
*/
set transactional messaging full
begin transaction
declare @Q varchar(100)
select @Q =
“ibm_mq:CHANNEL2/TCP/HOST_2(7371)?qmgr=QM2,
queue=QUEUE_2”
    select msgsend(‘a message’, ‘sub 1’)
    insert into T values (100)
    select msgrecv(@Q)
rollback
/*
Note: Rollback will undo work done by msgsend( ), msgrecv( ), and
insert.
*/
```

9. Using Messages Within Database Triggers

By using database triggers, DML events occurring within the relational database can be sent to the MQ message bus in real time. In the following example, the database trigger sends a “New Employee” notification to the MQ message bus whenever a new employee is added to the “employees” table. The message has the form:
NEW_EMPLOYEE(last_name, first_name, employeei_Id)

The SQL code for the trigger is as follows:

```
create trigger newEmployee on employess for insert
as
declare @Q  varchar(100)
select @Q =
“ibm_mq:CHANNEL2/TCP/HOST_2(7371)?qmgr=QM2,
queue=QUEUE_2”
    select msgsend(
‘NEW_EMPLOYEE(employee,’
+ inserted.last_name
+ ‘,’ + inserted.first_name
+ ‘,’ + inserted.emp_id
+ ‘)’, @Q)
        from inserted
```

In the next example, the database trigger sends a “New Employee” notification to the MQ message bus whenever a new employee is added to the “employees” table. The message is sent as an SQLX message.

create trigger newEmployee on employess for insert
as
declare @Q varchar(100)
select @Q =
“ibm_mq:CHANNEL2/TCP/HOST_2(7371)?qmgr=QM2,
queue=QUEUE_2”
select msgsend(
(select inserted.last_name, inserted.first_name,
inserted.emp_id from inserted FOR XML),
@Q)

If the insert had been:
insert into employees (last_name, first_name, emp_id)
values (‘Smith’, ‘Joe’, 9876)

then, the message that is sent to the messaging system would be:

<resultset xmlnl:xsi=”http://www.w3.org/2001/XMLSchema-instance”>
<row>
<last_name>Smith</last_name>
<first_name>Joe</first_name>
<emp_id>9876</emp_id>
</row>
</resultset>

10. Q Engines

This feature is implemented to prevent sessions performing messaging operations from affecting the performance of sessions that are not performing messaging. All API calls that send and receive messages to the messaging system are performed in a separate DBMS engine (process) known as a Q engine. At the point of the SQL messaging operation call, the Sybase RDBMS kernel will schedule the messaging operation from the current DBMS engine onto the Q engine. When the API call returns, the task is scheduled back on the DBMS engine. For scalability, there can be multiple Q engines to fully utilize the multiple processors available on multi-processors machines.

Security

Messaging systems such as MQ do not typically perform user authentication. However, the Sybase RDBMS uses existing user authentication for access, and the same scheme is used to authenticate users that attempt to send or receive messages. Therefore, the existing database login/user may be used to provide access control to the messaging systems to prevent impersonation.

Without such a concept of “messaging_role” any users in the database would be allowed to perform messaging operation, which is not really secure. Therefore, in accordance with the present invention, messaging_role is used to enhance the security of messaging operations between the database system and messaging bus (e.g., between ASE database and IBM MQ messaging system). To this end, the following messaging role features are provided:
Role: Roles provide permissions to perform a set of operations in a database system. They can either system defined or user defined
Grant: The Grant command assigns permissions to individual users or groups of users and roles. For example:
grant role sso_role to mary
In this example, sso_role is a system-defined role with special privileges and is being assigned to a user named mary. Upon the execution of this command, user mary will be allowed to perform all the operations that a user with sso_role is permitted to do.
Revoke: This command revokes permissions to individual users, groups of users, and roles.
For example:
revoke role sa_role to robert
In this example, sa_role is a system-defined role with special privileges and is being
revoked from user name robert.
messaging_role: Messaging_role is a new system defined role that is implemented to control the privileges when dealing with messaging operations from within the ASE database server. A user needs to have the privileges assigned by this role to exchange messages between the server (ASE) and the message bus, and also needs it to perform administrative tasks related to messaging operations. As an example, a user who does not have a messaging_role assigned to him will not be able to perform operations like msgrecv() or msgsend() to receive or send messages from within the database system (e.g., ASE) to the message bus (e.g., IBM MQ message bus). Any attempt to do so will be flagged as an error.

The following example illustrates this in further detail:
1. A new login/user named usr1 is being added to the database
$SYBASE/$SYBASE_OCS/bin/isql-Usa-P-Slinuxxml20_{—}13696-linterfaces
1>sp_addlogin ‘usr1’,‘abcdef123456’
2>go
2. The newly added user does not have any permission to exchange messages. In this step, the following will try to execute a messaging operations to show that the attempt will fail
$SYBASE/$SYBASE_OCS/bin/isql -Uusr1-Pabcdef123456-Slinuxxml2013696-linterfaces
1>select
msgsend(“rtms_dynload_{—}010”,“tibco_jms:tcp://linuxxml2:18301?queue=queue.sample,user =loginsa,password=abcdef123456”)
2>go
Msg 10353, Level 14, State 28:
Line 1:
You must have any of the following role(s) to execute this command/procedure: ‘messaging_role’. Please contact a user with the appropriate role for help.
3. In this step, the following will grant the permission to this user so that this user can subsequently do messaging operations
$SYBASE/$SYBASE_OCS/bin/isql-Usa-P-Slinuxxm12013696-linterfaces
1>sp_role ‘grant’,‘messaging_role’,usr1
2>go
4. In this step, the following will repeat the messaging operation to show that with the right privileges (i.e., messaging_role) the messaging operation would be allowed to proceed
$SYBASE/$SYBASE_OCS/bin/isql-Uusr1-Pabcdef123456-Slinuxxm12013696-linterfaces
1>select
msgsend(“rtms_dynload_{—}010”,“tibco_jms:tcp://linuxxml2:18301?queue=queue.sample,user =loginsa,password=abcdef123456”)
2>go
ID:EMS-SERVER.7B6443C5630F3:1
(1 row affected)
5. In this step, the following will revoke the privileges to exchanges messages and demonstrate that the messaging operation will fail
$SYBASE/$SYBASE_OCS/bin/isql-Usa-P-Slinuxxml20_{—}13696-linterfaces
1>sp_role ‘revoke’,‘messaging_role’,usr1
2>go
$SYBASE/$SYBASE_OCS/bin/isql-Uusr1-Pabcdef123456-Slinuxxml20_{—}13696-linterfaces
1>select
msgsend(“rtms_dynload_{—}010”,“tibco_jms:tcp://linuxxml2:18301?queue=queue.sample,user =loginsa,password=abcdef123456”)
2>go
Msg 10353, Level 14, State 28:
Line 1:

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. In a database system, a method for providing real-time message support for improved database connectivity, the method comprising:
defining Structured Query Language (SQL) extensions having commands that provide message-based connectivity for databases;
receiving an SQL statement including a command specifying that a message be sent for communicating particular database data;
upon execution of said SQL statement by the database system, creating an outbound message for communicating said particular database data to a destination; and
posting said outbound database to a message bus, whereupon said particular database data is communicated asynchronously to the destination.

2. The method of claim 1, wherein said creating step includes: creating an outbound message having a payload for reporting database data.

3. The method of claim 2, wherein said payload stores database data, said database data comprising information having an SQL data type.

4. The method of claim 1, further comprising: receiving an SQL statement including a command specifying that a message be received for
communicating particular database data from another location; and upon execution of said SQL statement by the database system, waiting a prescribed amount of time for an inbound message to arrive for communicating said particular database data from the other location.

5. The method of claim 1, wherein said SQL statement is associated with a database trigger that operates pursuant to a prescribed database event, so that said outbound message is created and posted upon occurrence of said prescribed database event.

6. The method of claim 5, wherein the prescribed database event comprises changes to database data in the database system.

7. The method of claim 5, wherein said outbound message is created and posted immediately in real-time upon occurrence of said prescribed database event, without polling for the event.

8. The method of claim 5, wherein said database trigger operates pursuant to execution of an SQL statement having an SQL DML (Data Manipulation Language) command.

9. The method of claim 1, wherein said SQL extensions provide SQL-based programmatic access to messaging features of said message bus.

10. A computer-readable medium having processor-executable instructions for performing the method of claim 1.

11. A downloadable set of processor-executable instructions for performing the method of claim 1.

12. A database system providing real-time message support, the system comprising:
a database storing database data;
Structured Query Language (SQL) extensions having commands that provide message-based connectivity for databases;
an execution module for receiving an SQL statement including a command specifying that a message be sent for communicating particular database data; and
a real-time messaging system for creating an outbound message for communicating said particular database data to a destination upon execution of said SQL statement by the database system, and for posting said outbound database to a message bus, whereupon said particular database data is communicated asynchronously to the destination.

13. The system of claim 12, wherein the outbound message includes a payload for reporting database data.

14. The system of claim 13, wherein said payload stores database data, said database data comprising information having an SQL data type.

15. The system of claim 12, wherein said real-time messaging system includes logic for receiving an SQL statement including a command specifying that a message be received for communicating particular database data from another location, and for waiting a prescribed amount of time for an inbound message to arrive for communicating said particular database data from the other location.

16. The system of claim 12, wherein said SQL statement is associated with a database trigger that operates pursuant to a prescribed database event, so that said outbound message is created and posted upon occurrence of said prescribed database event.

17. The system of claim 16, wherein the prescribed database event comprises changes to database data in the database system.

18. The system of claim 16, wherein said outbound message is created and posted immediately in real-time upon occurrence of said prescribed database event, without polling for the event.

19. The system of claim 16, wherein said database trigger operates pursuant to execution of an SQL statement having an SQL DML (Data Manipulation Language) command.

20. The system of claim 12, wherein said SQL extensions provide SQL-based programmatic access to messaging features of said message bus.

21. A database system providing built-in, real-time messaging support, the system comprising:
a database storing database data;
a parser having native support for a language syntax providing real-time messaging;
an execution unit, operating in response to commands parsed by the parser, for sending outbound messages in response to real-time changes to the database data; and
a message bus for posting outbound messages for asynchronous delivery to a destination.

22. The system of claim 21, wherein the outbound message includes a payload for reporting database data.

23. The system of claim 22, wherein said payload stores database data, said database data comprising information having an SQL data type.

24. The system of claim 21, wherein said system includes logic for parsing and executing a statement having a command specifying that a message be received for communicating particular database data from another location.

25. The system of claim 21, wherein some of said messages are associated with a database trigger that operates pursuant to a prescribed database event, so that a particular outbound message is created and posted upon occurrence of said prescribed database event.

26. The system of claim 25, wherein the prescribed database event comprises changes to database data in the database system.

27. The system of claim 25, wherein said particular outbound message is created and posted immediately in real-time upon occurrence of said prescribed database event, without polling for the event.

28. The system of claim 25, wherein said database trigger operates pursuant to execution of a statement having a DML (Data Manipulation Language) command.

29. The system of claim 21, wherein said language syntax provides SQL-based programmatic access to messaging features of said message bus.

30. The system of claim 21, wherein said language syntax includes a “message send” command for sending outbound messages.

31. The system of claim 30, wherein said “message send” command includes a parameter specifying a message data payload for the message being sent.

32. The system of claim 31, wherein said “message send” command includes a parameter specifying a URL of a destination that the message is being sent to.

33. The system of claim 31, wherein said “message send” command includes a parameter for specifying message options.

34. The system of claim 21, wherein said language syntax further includes a “message receive” command for receiving inbound messages.

35. The system of claim 34, wherein said “message receive” command includes a parameter specifying a timeout argument indicating how long the system should wait to receive a message before timing out.

36. The system of claim 34, wherein said “message receive” command includes a parameter specifying a “return type” argument for indicating how the system should treat an inbound message's payload.

37. A method for providing real-time messaging support to a database, the method comprising:
providing native language support for real-time messaging commands in query language statements;
executing said commands during operation of the database, for creating real-time messages reporting changes to the database data; and
posting said real-time messages to a message bus, for asynchronous delivery to a destination.

38. The method of claim 37, wherein said message bus supports IBM MQ.

39. The method of claim 37, wherein said query language statements comprise Structured Query Language (SQL) statements.

40. The method of claim 37, further comprising: executing said commands during runtime operation of the database, for specifying an incoming message for the database; and
upon arrival of said incoming message, formatting the message so that a particular SQL data type may be extracted from the message.

41. In a database system, a method for providing real-time message support that preserves transaction integrity of transactions that span across the database systems and a message bus, the method comprising:
defining Structured Query Language (SQL) extensions having commands that provide user level transactional integrity control that is preserved during SQL statement execution;
receiving an SQL statement including a command specifying that a message be sent for communicating particular database data;
upon execution of said SQL statement by the database system, creating an outbound message for communicating said particular database data to a destination; and
posting said outbound database to a message bus, whereupon said particular database data is communicated asynchronously to the destination.

42. A method for providing real-time messaging support to a database, that provides fine grain access control security that determines who is allowed to exchanged messages and who is not allowed to exchange messages with a message bus, the method comprising:
providing native language support for real-time messaging commands in query language statements that specifies security privileges;
executing said commands during operation of the database, for creating real-time messages reporting changes to the database data; and
posting said real-time messages to a message bus, for asynchronous delivery to a destination.
